(19) United States
(12) Patent Application Publication
(10) Pub. No.: US 2007/0074398 A1
(43) Pub. Date: Apr. 5, 2007

(54) Method of manufacturing subframe for vehicles

(75) Inventor: Hui Choun Moon, Gyeonggi-do (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 11/297,863

(22) Filed: Dec. 8, 2005

(30) Foreign Application Priority Data
Sep. 30, 2005 (KR) 10-2005-0091898

(51) Int. Cl. B21D 53/88; B60G 7/02

(52) U.S. Cl. 29/897.2; 280/124.109

(57) ABSTRACT

Methods for manufacturing a vehicle subframe are provided which can be performed in a simplified manner and with reduced area of welded portions, thus preventing the completed subframe from being undesirably deformed and maintaining high precision of the subframe.

### CROSS-REFERENCE TO RELATED APPLICATIONS

The present application is based on, and claims priority from, Korean Application Serial Number 10-2005-0091898, filed on Sep. 30, 2005, the disclosure of which is hereby incorporated by reference herein in its entirety.

### FIELD OF THE INVENTION

The present invention relates to methods of manufacturing subframes for vehicles and, more in preferred aspects, to a method of manufacturing a subframe, which is highly accurate despite comprising a simple process.

### BACKGROUND OF THE INVENTION

A subframe of a vehicle is provided below an engine room in a front portion of the vehicle body and generally supports a suspension arm, an engine and a transmission. Typically, the subframe has a quadrilateral shape and is mounted at four corners thereof to a lower portion of the vehicle body.

Therefore, high precision of the subframe can be important to ensure a precisely tuned state of wheels which are coupled to the vehicle body through the suspension arm. To mount the subframe to the vehicle body, mounting positions of the four corners of the subframe must be precisely set.

The subframe is typically manufactured by welding a plurality of parts to one another. As the number of welded parts increases, the precision of the resulting subframe can be compromised. For instance, after welding and manufacturing is completed, thermal deformation can occur which can reduce the precision of the manufactured subframe.

Additionally, when a vehicle crash occurs, the subframe serves to absorb impact from the front portion of the vehicle. If the subframe comprises an excessively large number of parts assembled by welding, the subframe may not sufficiently absorb the impact and may more readily crack.

It is also preferable that a method of manufacturing the subframe be as simple as possible and that the equipment required to manufacture the subframe be relatively compact.

The information set forth in this Background of the Invention section is only for enhancement of understanding of the invention and should not be taken as an acknowledgement or any form of suggestion that this information forms the prior art that is already known to a person skilled in the art.

### SUMMARY OF THE INVENTION

In one aspect, a method of manufacturing a subframe for vehicles is provided which can enable the subframe to be manufactured through a relatively simple process using relatively small equipment. The present methods can provide notable advantages, including reduced costs of manufacture of a subframe, reduced area of welded portions, which in turn can avoid undesired deforming of the produced subframe.

In one preferred aspect, a method of manufacturing a subframe for vehicles includes manufacturing a front member including a front side of the quadrilateral subframe forming a front portion of a vehicle body, a left member and a right member coupled to respective opposite ends of the front member and extending predetermined lengths towards a rear portion of the vehicle body, thus forming opposite sides of the subframe, and a rear member including a rear side of the quadrilateral subframe forming the rear portion of the vehicle body and coupled at opposite ends thereof to the left member and right member. Junctions between the left member, the right member and the front member and junctions between the rear member, the left member and the right member are suitably welded.

It is understood that the term “vehicle” or “vehicular” or other similar terms as used herein is inclusive of motor vehicles in general such as passenger automobiles, buses, trucks, various commercial vehicles, watercraft including a variety of boats, aircraft, and the like.

Other aspects of the invention are discussed below.

### BRIEF DESCRIPTION OF THE DRAWINGS

For a better understanding of the nature and objects of the present invention, reference should be made to the following detailed description with the accompanying drawings, in which:

FIG. 1 is a view showing a subframe for vehicles to be manufactured by a method according to an embodiment of the present invention;

FIG. 2 is a flowchart of the method of manufacturing a subframe for vehicles according to the present invention; and

FIG. 3 is a view illustrating the method of manufacturing the subframe according to the present invention;

### DETAILED DESCRIPTION OF THE PREFERRED EMBODIMENTS

As discussed above, methods for manufacturing a subframe for a vehicle are provided, which may comprise: (a) manufacturing (i) a front member which comprises a front side of a quadrilateral subframe forming a front portion of a vehicle body, (ii) a left member and (iii) a right member coupled to respective opposite ends of the front member and extending predetermined lengths towards a rear portion of the vehicle body, thus forming opposite sides of the subframe; (b) manufacturing a rear member comprising a rear side of the quadrilateral subframe forming the rear portion of the vehicle body and coupled at opposite ends thereof to the left member and right member.

Junctions may be suitably affixed such as through welding between the left member, the right member and the front member and junctions between the rear member, the left member and the right member.

In certain preferred aspects, each of the front member, the rear member, the left member and the right member is manufactured by integrating an upper part and a lower part, which are separately produced, with each other into a single body.

Also preferred is where the front member comprises: vehicle body mounting holes formed in the respective opposite ends of the front member so as to mount the front member to the vehicle body; and an engine roll mounting part provided on the front member, and the rear member comprises vehicle body mounting holes formed in the respective opposite ends thereof so as to mount the rear member to the vehicle body.

A preferred embodiment of the present invention is now described with reference to the accompanying drawings.

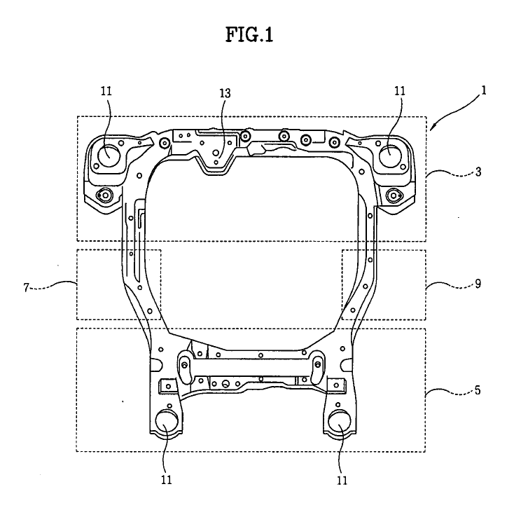

Referring to FIG. 1, a preferred subframe 1 of a vehicle suitably includes a front member 3, a rear member 5, a left member 7 and a right member 9. The front member 3 suitably has vehicle body mounting apertures or holes 11, which are respectively formed in opposite ends of the front member 3 so as to mount the front member 3 to a vehicle body, and an engine roll mounting part 13, which is integrally provided preferably on a medial portion of the front member 3. The rear member 5 suitably has vehicle body mounting apertures holes 11 which are integrally formed in respective opposite ends of the rear member 5 so as to mount the rear member 5 to the vehicle body.

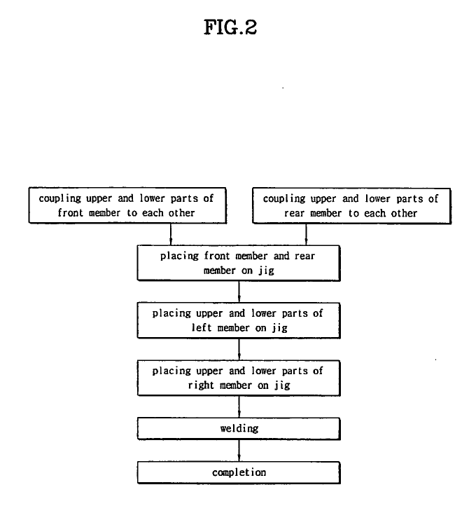

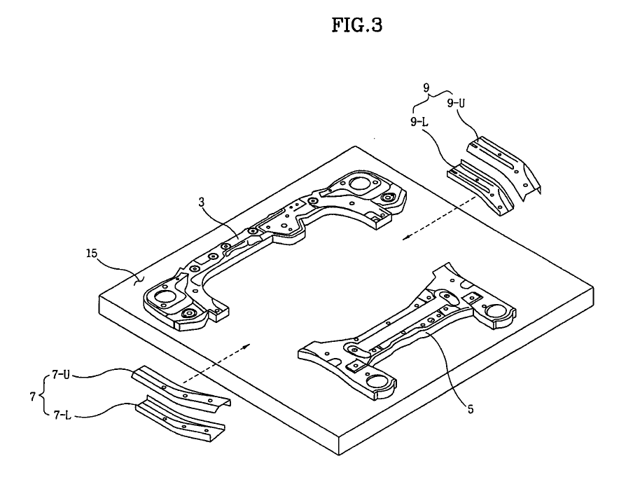

Referring to FIGS. 2 and 3, to manufacture the subframe 1, an upper part and lower part of each of the front member 3 and the rear member 5 are suitably coupled to each other, thus manufacturing the front member 3 and the rear member 5.

Thereafter, the front member 3 and the rear member 5, which are suitably manufactured by welding the upper parts and the lower parts to each other, are placed on a jig 15.

Subsequently, an upper part 7-U and a lower part 7-L of the left member 7 and an upper part 9-U and a lower part 9-L of the right member 9 are preferably placed on the jig 15 between the front member 3 and the rear member 5 which have been placed on the jig 15.

The parts, which are placed on the jig 15, are thereafter coupled together suitably by welding, thus completing the subframe 1.

In other words, a junction between the front member 3, the upper part 7-U and the lower part 7-L of the left member 7, a junction between the front member 3, the upper part 9-U and the lower part 9-L of the right member 9, a junction between the rear member 5, the upper part 7-U and the lower part 7-L of the left member 7, a junction between the rear member 5, the upper part 9-U and the lower part 9-L of the right member 9, a junction between the upper part 7-U and the lower part 7-L of the left member 7, and a junction between the upper part 9-U and the lower part 9-L of the right member 9 are welded, preferably substantially simultaneously, thus completing the subframe 1.

In the described processes of placing the upper part 7-U and the lower part 7-L of the left member 7 and the upper part 9-U and the lower part 9-L of the right member 9 on the jig 15 may be suitably changed in sequence or be simultaneously performed.

As described above, in the process of manufacturing the subframe 1, welding is conducted only on front and rear ends of the left and right members 7 and 9, but not at junctions between the upper and lower parts of elements of the subframe 1. A reduced area of welded portions can prevent the completed subframe 1 from becoming deformed, thus maintaining high accuracy assembly, which can be further ensured by using the jig 15 during the manufacturing process.

Therefore, the subframe 1 can be easily and precisely mounted to the vehicle body through the four vehicle body mounting apertures or holes 11, which maintain the desired distances therebetween. Furthermore, the subframe 1 can provide an effectively precise mounting position at which a suspension system is mounted to the subframe 1, thus ensuring the precisely tuned state of the wheels with respect to the vehicle body.

Additionally, because the area of welded portions around the vehicle body mounting holes 11 is reduced, a change in characteristics of media on a wave transmission path through the welded portions can be minimized. Consequently, bushings mounted to the vehicle body mounting holes 11 can effectively absorb vibration and noise which may be e.g. transmitted from the engine or the road.

In addition, the subframe 1, having reduced welded portions, can exhibit a reliable support function when a vehicle crash occurs, thus enhancing the stability of the vehicle. Furthermore, due to the reduced number of welded parts, a decreased amount of adjustments will be required, thus simplifying the process of manufacturing the subframe 1.

Moreover, in certain preferred methods of the present invention, the subframe 1 is manufactured by welding the front member 3, the rear member 5, the left member 7 and the right member 9, which are separately manufactured, into a single body. Therefore, compared to a conventional hydro-forming technique, which forms a shape in which a front member 3, left member 7 and right member 9 are integrally assembled with each other, the size of the equipment required to manufacture the subframe is reduced. Additionally, equipment and processes for correcting undesired bends and twists of the subframe are not required. As a result, the manufacturing costs can be notably reduced.

Methods of the invention can enable manufacture of a subframe through a relatively simple process using relatively small equipment, thus reducing the manufacturing costs of the subframe. Furthermore, the present invention can minimize the area of welded portions of the subframe, thus preventing the completed subframe from being undesirably deformed, and thereby enabling production of a high precision subframe.

While the invention has been described with reference to specific embodiments, modifications and variations may be constructed without departing from the scope of the invention, which is defined in the following claims.

What is claimed is:

1. A method of manufacturing a subframe for a vehicle, comprising:
manufacturing a front member which comprises a front side of a quadrilateral subframe forming a front portion of a vehicle body, a left member and a right member coupled to respective opposite ends of the front member and extending predetermined lengths towards a rear portion of the vehicle body, thus forming opposite sides of the subframe, and a rear member comprising a rear side of the quadrilateral subframe forming the rear portion of the vehicle body and coupled at opposite ends thereof to the left member and right member; and
welding junctions between the left member, the right member and the front member and junctions between the rear member, the left member and the right member.

2. The method of claim 1, wherein each of the front member, the rear member, the left member and the right member is manufactured by integrating an upper part and a lower part, which are separately produced, with each other into a single body.

3. The method of claim 2, wherein
the front member comprises: vehicle body mounting holes formed in the respective opposite ends of the front member so as to mount the front member to the vehicle body; and an engine roll mounting part provided on a medial portion of the front member, and
the rear member comprises vehicle body mounting holes formed in the respective opposite ends thereof so as to mount the rear member to the vehicle body.

4. The method of claim 3, wherein
the front member and the rear member, each being manufactured by welding the upper part and the lower part to each other, are placed on a jig;
the upper part and the lower part of the left member and the upper part and the lower part of the right member are placed on the jig between the front member 3 and the rear member; and
a junction between the front member, the upper part and the lower part of the left member, a junction between the front member, the upper part and the lower part of the right member, a junction between the rear member, the upper part and the lower part of the left member, a junction between the rear member, the upper part and the lower part of the right member, a junction between the upper part and the lower part of the left member, and a junction between the upper part and the lower part of the right member are at least substantially simultaneously welded.

5. A method of manufacturing a subframe for a vehicle, comprising:
(a) manufacturing (i) a front member which comprises a front side of a quadrilateral subframe forming a front portion of a vehicle body, (ii) a left member and (iii) a right member coupled to respective opposite ends of the front member and extending predetermined lengths towards a rear portion of the vehicle body, thus forming opposite sides of the subframe,
(b) manufacturing a rear member comprising a rear side of the quadrilateral subframe forming the rear portion of the vehicle body and coupled at opposite ends thereof to the left member and right member.

6. The method of claim 5 further comprising affixing junctions between the left member, the right member and the front member and junctions between the rear member, the left member and the right member.

7. The method of claim 5 wherein each of the front member, the rear member, the left member and the right member is manufactured by integrating an upper part and a lower part, which are separately produced, with each other into a single body.

8. The method of claim 7 wherein
the front member comprises: vehicle body mounting holes formed in the respective opposite ends of the front member so as to mount the front member to the vehicle body; and an engine roll mounting part provided on the front member, and
the rear member comprises vehicle body mounting holes formed in the respective opposite ends thereof so as to mount the rear member to the vehicle body.
